(19) United States
(12) Patent Application Publication
(10) Pub. No.: US 2016/0134127 A1
(43) Pub. Date: May 12, 2016

(54) WIRELESS POWER SYSTEM

(71) Applicant: EATON CORPORATION, Cleveland, OH (US)

(72) Inventors: YI YANG, MILWAUKEE, WI (US); CHARLES JOHN LUEBKE, HARTLAND, WI (US); STEVEN CHRISTOPHER SCHMALZ, FRANKLIN, WI (US); BIRGER PAHL, MILWAUKEE, WI (US); QIANG FU, MILWAUKEE, WI (US)

(73) Assignee: EATON CORPORATION, CLEVELAND, OH (US)

(21) Appl. No.: 14/536,807

(22) Filed: Nov. 10, 2014

(51) Int. Cl. H02J 5/00

(52) U.S. Cl. CPC H02J 5/005

(57) ABSTRACT

A wireless power system including a wireless power transmitter coupled to a power source and being structured to receive power from the power source, the wireless power transmitter including a transmitter coil structured to wirelessly transmit said power; and a wireless power receiver including a receiver coil structured to receive the power from the transmitter coil, the wireless power receiver being coupled to and load and structured to provide the power to the load, wherein the wireless power transmitter is structured to be installed in a junction box disposed in a floor, a wall, or a ceiling, or inside an exterior surface of equipment; and wherein the wireless power transmitter is structured to wirelessly transmit the power to the wireless power receiver disposed outside of the floor, the wall, or the ceiling.

### BACKGROUND

1. Field

The disclosed concept relates generally to wireless power systems, and in particular, to wireless power systems configured for use with existing junction boxes.

2. Background Information

Electricity is often provided to electric devices via an electrical receptacle in the wall or floor of a room. Electrical receptacles generally include a number of sockets which physical interface with a plug of an electrical cord. Over time, this physical interaction can cause the electrical receptacle and the plug to become worn out. In addition to general wear on the electrical receptacle and plug, damage to the plug, such as bent prongs, can be caused by pulling on the electrical cord. In particular, tripping on the electrical cord can cause the prong of the electrical plug to bend, in addition to possibly causing an injury to the person tripping over the electrical cord.

Electrical receptacles also include a receptacle cover. The cover is exposed and can be hit and damaged. In particular, in the case of electrical receptacles located in the floor, the cover can be exposed to regular physical contact, such as being stepped on, which can lead to it being damaged. Conference rooms generally have electrical receptacles located in the floor. These electrical receptacles face a high risk of physical damage. Additionally, these electrical receptacles lead to electrical cords being located on the ground where they present a tripping risk to people walking in the area.

In the case that an electrical receptacle is located outdoors, the environmental damage to the electrical receptacle can be significant.

It would be desirable to provide electrical power while reducing or avoiding these limitations of electrical receptacles. There is thus room for improvement in electrical distribution systems.

### SUMMARY

These needs and others are met by embodiments of the disclosed concept in which a wireless power system includes a wireless power transmitter disposed in a floor, wall, or ceiling, and is structured to wirelessly transmit power to a wireless power receiver disposed outside of the floor, wall, or ceiling.

In accordance with one aspect of the disclosed concept, a wireless power system includes a wireless power transmitter coupled to a power source and being structured to receive power from the power source, the wireless power transmitter including a transmitter coil structured to wirelessly transmit said power; and a wireless power receiver including a receiver coil structured to receive the power from the transmitter coil, the wireless power receiver being coupled to a load and structured to provide the power to the load, wherein the wireless power transmitter is structured to be installed in a junction box disposed in a floor, a wall, or a ceiling, or inside an exterior surface of equipment; and wherein the wireless power transmitter is structured to wirelessly transmit the power to the wireless power receiver disposed outside of the floor, the wall, or the ceiling.

In accordance with another aspect of the disclosed concept, a wireless power system includes a power source; a load; a wireless power transmitter coupled to the power source and being structured to receive power from the power source and to wirelessly transmit said power; and a wireless power receiver structured to receive the power from the wireless power transmitter, the wireless power receiver being coupled to the load and structured to provide the power to the load, wherein the wireless power transmitter is disposed in the junction box disposed in a floor, wall, or ceiling, or inside an exterior surface of equipment, and the wireless power receiver is disposed outside of the floor, wall, or ceiling.

### BRIEF DESCRIPTION OF THE DRAWINGS

A full understanding of the disclosed concept can be gained from the following description of the preferred embodiments when read in conjunction with the accompanying drawings in which:

FIG. 1 is a circuit diagram of a wireless power system in accordance with an example embodiment of the disclosed concept;

FIG. 2 is a schematic diagram of a wireless power system including a wireless power transmitter disposed in a floor in accordance with an example embodiment of the disclosed concept;

FIG. 3 is a schematic diagram of a wireless power system including a cover plate in accordance with an example embodiment of the disclosed concept;

FIG. 4 is a schematic diagram of a wireless power system including a wireless power transmitter disposed in a ceiling in accordance with an example embodiment of the disclosed concept;

FIG. 5 is a schematic diagram of a wireless power system including a wireless power transmitter disposed in a wall in accordance with an example embodiment of the disclosed concept; and

FIG. 6 is a schematic diagram of a wireless power system including a wireless power transmitter disposed inside an exterior surface of equipment in accordance with an example embodiment of the disclosed concept.

### DESCRIPTION OF THE PREFERRED EMBODIMENTS

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts are “coupled” together shall mean that the parts are joined together either directly or joined through one or more intermediate parts.

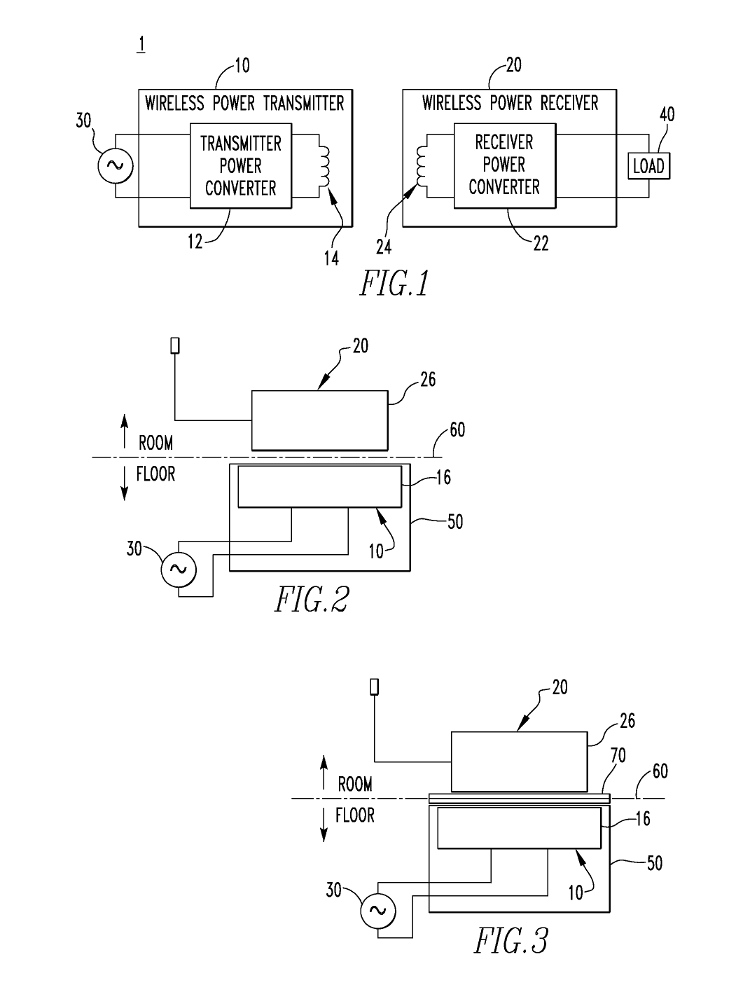

A schematic diagram of a wireless power system 1 in accordance with an example embodiment of the disclosed concept is shown in FIG. 1. The wireless power system 1 includes a wireless power transmitter 10 and a wireless power receiver 20. The wireless power transmitter 10 is electrically connected to a power source 30 and receives electrical power from the power source. The wireless power transmitter 10 transmits power received from the power source 30 to the wireless power receiver 20. The wireless power receiver 20 receives the power wirelessly transmitted from the wireless power transmitter 10 and outputs the power to a load 40 electrically connected to it.

The wireless power transmitter 10 includes a transmitter power converter 12 and a transmitter coil 14. The transmitter power converter 12 is electrically connected to the power source 30 and is structured to receive power from the power source 30. The transmitter power converter 12 includes circuitry to convert the power from the power source 30 to be wirelessly transmitted by the transmitter coil 14.

The transmitter coil 14 is electrically connected to an output of the transmitter power converter 12 and is structured to receive and wirelessly transmit the power output from the transmitter power converter 12.

The wireless power receiver 20 includes a receiver power converter 22 and a receiver coil 24. The receiver coil 24 is structured to receiver the power transmitted by the transmitter coil 14 the wireless power transmitter 10. In more detail, the transmitter coil 14 and the receiver coil 24 become inductively coupled whereby current flowing through the transmitter coil 14 creates an electromagnetic field that induces current to flow through the receiver coil 24. The transmitter coil 14 and the receiver coil 24 may also be in resonance to help power flow in a loosely coupled system.

The receiver power converter 22 is electrically connected to the receiver coil 24 and is structured to receive the output of the receiver coil 24. The receiver power converter 22 includes circuitry 12 to convert the power receiver from the receiver coil 24 so that it can be used by the load 40.

The power source 30 is any suitable power source. The power source 30 may be an AC power source or a DC power source. In some example embodiments of the disclosed concept, the power source is a residential power source such as, without limitation, a 100 VAC, a 120 VAC, or a 230 VAC power source.

The load 40 may be any suitable type of electric load such as, without limitation, a computer, a light, or any other type of electric device.

FIG. 2 is a schematic view of the wireless power system 1 having the wireless power transmitter 10 disposed in a floor 60 in accordance with an example embodiment of the disclosed concept. The wireless power transmitter 10 is located in the floor 60 and the wireless power receiver 20 is located outside the floor 60.

The wireless power transmitter 10 is housed in a transmitter enclosure 16 and the wireless power receiver 20 is housed in a receiver enclosure 26. The transmitter enclosure 16 substantially forms the exterior shape of the wireless power transmitter 10 and encloses the internal electronics of the wireless power transmitter 10 such as the transmitter power converter 12 and the transmitter coil 14. At least a portion of the transmitter enclosure 16 is composed of a material that is substantially transparent to electromagnetic radiation such as, without limitation, plastic. This allows the transmitter coil 14 to wirelessly transmit power outside of the transmitter enclosure 16.

Similar to the transmitter enclosure 16, the receiver enclosure 26 substantially forms the exterior shape of the wireless power receiver 20 and encloses the internal electronics of the wireless power receiver 20 such as the receiver power converter 22 and the receiver coil 24. At least a portion of the receiver enclosure 26 is composed of a material that is substantially transparent to electromagnetic radiation such as, without limitation, plastic. This allows the receiver coil 24 to receive power transmitter from the transmitter coil 14.

The wireless power transmitter 16 is installed inside of a junction box 50 disposed below the flooring 60. To this extent, the wireless power transmitter 16 may be sized to fit within the junction box 50 without altering the size of the junction box 50. The junction box 50 would generally house a conventional power receptacle. Thus, if a conventional receptacle were to be upgraded, the conventional power receptacle could be removed and the wireless power transmitter 10 installed inside the junction box 50 with minimal labor.

Referring to FIG. 3, a wireless power system 1 in accordance with an example embodiment of the disclosed concept similar to the example embodiment of FIG. 2 is shown. As shown in FIG. 3, a cover plate 70 is installed above the junction box 50. Some building codes require cover plates to be installed over junction boxes in order to provide convenient access to the junction box. The cover plate 70 is composed of a material that is substantially transparent to electromagnetic radiation such as, without limitation, plastic.

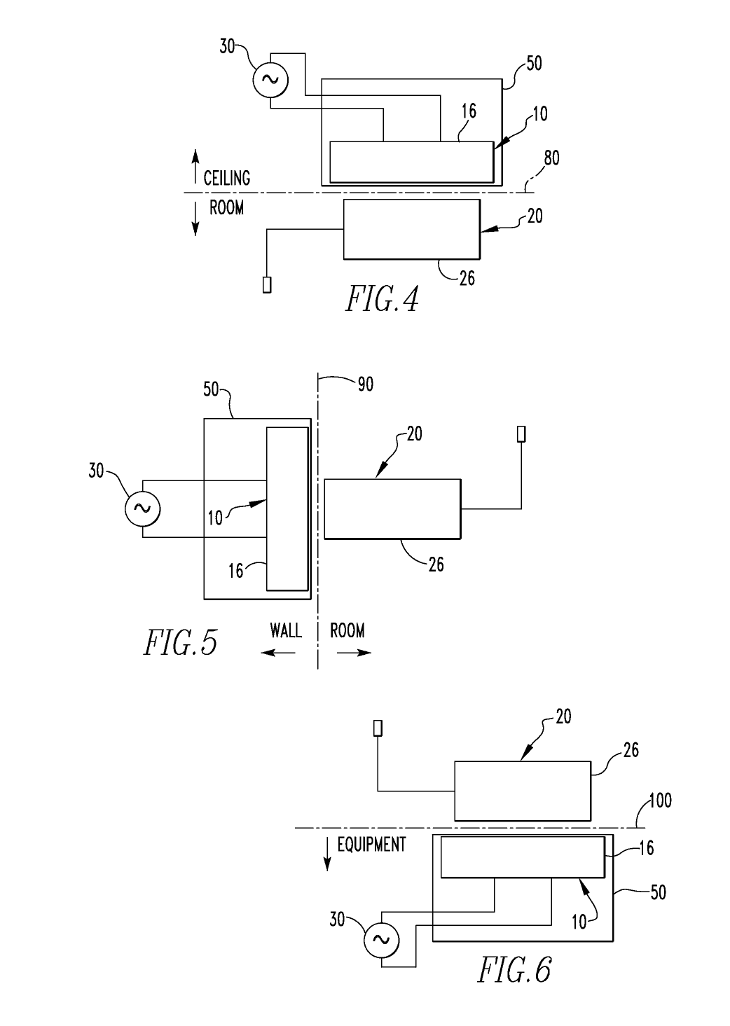

While FIG. 2 shows the wireless power transmitter 10 installed in the junction box 50 disposed in the floor 60, it is also contemplated that the wireless power transmitter 10 may be installed in junction boxes disposed in walls or ceilings. For example, FIG. 4 shows a wireless power system 1 in accordance with an example embodiment of the disclosed concept where the wireless power transmitter 10 is installed in the junction box 50 disposed inside of a ceiling 80 while the wireless power receiver 20 is disposed outside of the ceiling 80. FIG. 5 shows a wireless power system 1 in accordance with an example embodiment of the disclosed concept where the wireless power transmitter 10 is installed in the junction box 50 disposed inside of a wall 90 while the wireless power receiver 20 is disposed outside of the wall 90. Although not shown in FIGS. 4 and 5, it is contemplated that a cover plate, such as the cover plate 70 shown in FIG. 3, may be installed on the junction box 50 shown in FIGS. 4 and 5.

FIG. 6 is a schematic diagram of a wireless power system including a wireless power transmitter 16 disposed inside an exterior surface 100 of equipment. Many types of conventional equipment (e.g, without limitation, a generator) include an outlet that provides electrical power. In the wireless power system of FIG. 6, rather than using an outlet to provide power, the wireless power transmitter 10 is disposed inside the exterior surface 100 of the equipment and the wireless power receiver 20 is disposed outside the exterior surface 100 of the equipment. The wireless power transmitter 10 is structured to wirelessly transmit power to the wireless power receiver 20 through the exterior surface 100 of the equipment, thus eliminating the need for an outlet on the equipment. Although not shown in FIG. 6, it is contemplated that a cover plate, such as the cover plate 70 shown in FIG. 3, may be disposed between the wireless power transmitter 10 and the wireless power receiver 20. Although a junction box 50 is shown in FIG. 6, it is contemplated that the junction box 50 may be omitted without departing from the scope of the disclosed concept.

In each of FIGS. 2-6, the wireless power transmitter 10 is installed in the junction box 50 disposed in the floor 60, ceiling 80, or wall 90, or inside the exterior surface 100 of equipment, and the wireless power receiver 20 is disposed outside of the floor 60, ceiling 80, wall 90, or exterior surface 100 of the equipment. The wireless power transmitter 10 is structured to wirelessly transmit power to the wireless power receiver 20 through the floor 60, ceiling 80, wall 90, or exterior surface 100, or through the cover plate 70 if one is used. Thus, by employing the wireless power system 1, it is no longer necessary to physically plug electronic devices into an electrical receptacle installed in a floor, ceiling, or wall. As such, physical damage to cords and receptacles can be avoided. Furthermore, physical risks such as tripping over cords can be avoided.

Alignment of the wireless power transmitter 10 and wireless power receiver 20 may be assisted by mechanical, magnetic, or visual alignment aids disposed on or in the floor 60, cover plate 70, ceiling 80, wall 90, exterior surface 100, or the wireless power transmitter 10 or wireless power receiver 20 themselves. Retention of the wireless power transmitter 10 and wireless power receiver 20 may be assisted by a mechanical or magnetic retention mechanism which holds the wireless power transmitter 10 and/or wireless power receiver 20 in its position. The mechanical or magnetic retention mechanism may include a break free mechanism which allows the wireless power transmitter 10 and/or wireless power receiver 20 to be moved from its position when sufficient force is applied.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A wireless power system, comprising:
a wireless power transmitter coupled to a power source and being structured to receive power from the power source, the wireless power transmitter including a transmitter coil structured to wirelessly transmit said power; and
a wireless power receiver including a receiver coil structured to receive the power from the transmitter coil, the wireless power receiver being coupled to a load and structured to provide the power to the load,
wherein the wireless power transmitter is structured to be installed in a junction box disposed in a floor, a wall, or a ceiling, or inside an exterior surface of equipment; and wherein the wireless power transmitter is structured to wirelessly transmit the power to the wireless power receiver disposed outside of the floor, the wall, or the ceiling.

2. The wireless power system of claim 1, wherein the power source is an alternating current power source.

3. The wireless power system of claim 2, wherein the power source is one of a 100 VAC, 120 VAC, and a 230 VAC alternating current power source.

4. The wireless power system of claim 1, wherein the power source is a direct current power source.

5. The wireless power system of claim 1, wherein the wireless power transmitter includes a transmitter power converter; wherein the transmitter power converter is structured to convert the power from the power source for wireless transmission via the transmitter coil.

6. The wireless power system of claim 5, wherein the transmitter power converter is electrically connected to the power source.

7. The wireless power system of claim 1, wherein the wireless power receiver includes a receiver power converter; wherein the receiver coil is structured to receive power wirelessly transmitted by the wireless power transmitter; and wherein the receiver power converter is structured to convert the received power for use by the load.

8. The wireless power system of claim 7, wherein the receiver power converter is electrically connected to the load.

9. The wireless power system of claim 1, wherein the wireless power transmitter includes an enclosure that substantially forms the exterior shape of the wireless power transmitter,
wherein at least a portion of the enclosure is composed of a material that is substantially transparent to electromagnetic radiation.

10. The wireless power system of claim 1, wherein the wireless power receiver includes an enclosure that substantially forms the exterior shape of the wireless power receiver,
wherein at least a portion of the receiver enclosure is substantially transparent to electromagnetic radiation.

11. A wireless power system, comprising:
a power source;
a load;
a wireless power transmitter coupled to the power source and being structured to receive power from the power source and to wirelessly transmit said power; and
a wireless power receiver structured to receive the power from the wireless power transmitter, the wireless power receiver being coupled to the load and structured to provide the power to the load,
wherein the wireless power transmitter is disposed in a junction box disposed in a floor, wall, or ceiling, or inside an exterior surface of equipment, and the wireless power receiver is disposed outside of the floor, wall, or ceiling.

12. The wireless power system of claim 11, wherein the power source is an alternating current power source.

13. The wireless power system of claim 12, wherein the power source is one of a 100 VAC, a 120 VAC, and 230 VAC alternating current power source.

14. The wireless power system of claim 11, wherein the wireless power transmitter includes a transmitter power converter and a transmitter coil; wherein the transmitter power converter is structured to convert the power from the power source for wireless transmission via the transmitter coil.

15. The wireless power system of claim 14, wherein the transmitter power converter is electrically connected to the power source.

16. The wireless power system of claim 11, wherein the wireless power receiver includes a receiver power converter and a receiver coil; wherein the receiver coil is structured to receive power wirelessly transmitted by the wireless power transmitter; and wherein the receiver power converter is structured to convert the received power for use by the load.

17. The wireless power system of claim 16, wherein the receiver power converter is electrically connected to the load.

18. The wireless power system of claim 11, wherein the wireless power transmitter includes an enclosure that substantially forms the exterior shape of the wireless power transmitter,
wherein at least a portion of the enclosure is composed of a material that is substantially transparent to electromagnetic radiation.

19. The wireless power system of claim 11, wherein the wireless power receiver includes an enclosure that substantially forms the exterior shape of the wireless power receiver,
wherein at least a portion of the receiver enclosure is substantially transparent to electromagnetic radiation.

20. The wireless power system of claim 11, further comprising:
a cover plate installed on the junction box,
wherein the cover plate is composed of a material that is substantially transparent to electromagnetic radiation.
